(19) United States
(12) Patent Application Publication
(10) Pub. No.: US 2024/0253735 A1
(43) Pub. Date: Aug. 1, 2024

(54) SHIFTING DEVICE FOR HUMAN-POWERED VEHICLE, DRIVE UNIT FOR HUMAN-POWERED VEHICLE, CONTROL SYSTEM FOR HUMAN-POWERED VEHICLE, AND COMMUNICATION DEVICE FOR HUMAN-POWERED VEHICLE

(71) Applicant: Shimano Inc., Osaka (JP)

(72) Inventors: Kasumasa MITSUNARI, Osaka (JP); Keita MICHIKAWA, Osaka (JP); Yoshiyuki KASAI, Osaka (JP)

(21) Appl. No.: 18/392,326

(22) Filed: Dec. 21, 2023

(30) Foreign Application Priority Data
Jan. 30, 2023 (JP) 2023-012241

(51) Int. Cl. B62M 9/122; B62M 6/45

(52) U.S. Cl. CPC B62M 9/122; B62M 6/45

(57) ABSTRACT

A shifting device includes a transmission device, a first controller and a first communicator. The transmission device is configured to shift a transmission ratio of a human-powered vehicle. The first controller is configured to control the transmission device. The first communicator is configured to perform communication with a drive unit for a human-powered vehicle. The drive unit includes a motor configured to apply a propulsion force to the human-powered vehicle. In a case where the first controller shifts the transmission ratio. The first controller is configured to control the first communicator so that the first communicator sends first information to the drive unit in a case where the first controller shifts the transmission ratio. The first information includes at least one of information related to a shifting time of the transmission ratio and information related to a shifting period of the transmission ratio.

### CROSS-REFERENCE TO RELATED APPLICATIONS

This application claims priority to Japanese Patent Application No. 2023-012241, filed on Jan. 30, 2023. The entire disclosure of Japanese Patent Application No. 2023-012241 is hereby incorporated herein by reference.

### BACKGROUND

### Technical Field

The present disclosure generally relates to a shifting device for a human-powered vehicle, a drive unit for a human-powered vehicle, a control system for a human-powered vehicle, and a communication device for a human-powered vehicle.

### Background Information

Japanese Laid-Open Patent Publication No. 2013-47085 (Patent Document 1) discloses an example of a control device for a human-powered vehicle that controls a shifting device of the human-powered vehicle.

### SUMMARY

An objective of the present disclosure is to provide a shifting device for a human-powered vehicle, a drive unit for a human-powered vehicle, a control system for a human-powered vehicle, and a communication device for a human-powered vehicle that improve convenience for a user.

A shifting device in accordance with a first aspect of the present disclosure is for a human-powered vehicle. The shifting device comprises a transmission device, a first controller and a first communicator. The transmission device is configured to shift a transmission ratio of the human-powered vehicle. The first controller is configured to control the transmission device. The first communicator is configured to perform communication with a drive unit for a human-powered vehicle. The drive unit includes a motor configured to apply propulsion force to the human-powered vehicle. The first controller is configured to control the first communicator so that the first communicator sends first information to the drive unit in a case where the first controller shifts the transmission ratio. The first information includes at least one of information related to a shifting time of the transmission ratio and information related to a shifting period of the transmission ratio, to the drive unit. The shifting device according to the first aspect sends the first information, including at least one of the information related to the shifting time of the transmission ratio and the information related to the shifting period of the transmission ratio, to the drive unit. Thus, the drive unit performs control in accordance with the first information. This allows the shifting device to perform actuation independently of the control of the drive unit, thereby improving convenience for the user.

In accordance with a second aspect of the present disclosure, the shifting device according to the first aspect further comprises a second communicator configured to receive a shifting signal for shifting the transmission ratio from a shift-operating unit. The first controller is configured to control the first communicator so that the first communicator sends the first information to the drive unit in a case where the second communicator receives the shifting signal. With the shifting device according to the second aspect, the first controller controls the first communicator so that the first communicator transmits the first information to the drive unit in a case where the second communicator receives the shifting signal. This sends the first information to the drive unit in a preferred manner.

In accordance with a third aspect of the present disclosure, the shifting device according to the second aspect is configured so that the second communicator is configured to receive the shifting signal through wireless communication. The shifting device according to the third aspect simplifies the wiring.

In accordance with a fourth aspect of the present disclosure, the shifting device according to the second or third aspect is configured so that the first controller is configured to control the transmission device so that the transmission device initiates shifting of the transmission ratio at an initiation time after a predetermined period elapses in a case where the shifting signal is received,. The first information includes at least one of the initiation time and the predetermined period. With the shifting device according to the fourth aspect, the drive unit easily performs control in accordance with at least one of the initiation time and the predetermined period.

In accordance with a fifth aspect of the present disclosure, the shifting device according to any one of the first to fourth aspects is configured so that the first controller is configured to determine at least one of the shifting time and the shifting period in accordance with at least one of the transmission ratio prior to shifting and the transmission ratio subsequent to shifting. The shifting device according to the fifth aspect determines at least one of the shifting time and the shifting period that is suitable for at least one of the transmission ratio prior to shifting and the transmission ratio subsequent to shifting.

In accordance with a sixth aspect of the present disclosure, the shifting device according to any one of the first to fifth aspects is configured so that the first controller is configured to control the transmission device in accordance with a shifting signal sent from the drive unit. The shifting device according to the sixth aspect can perform shifting in accordance with the control of the drive unit.

In accordance with a seventh aspect of the present disclosure, the shifting device according to any one of the first to sixth aspects further comprises a communication housing provided with the first communicator and formed separately from the transmission device. With the shifting device according to the seventh aspect, the first communicator is provided in the communication housing formed separately from the transmission device. This avoids enlargement of the transmission device.

In accordance with an eighth aspect of the present disclosure, the shifting device according to any one of the first to seventh aspects is configured so that the first communicator is configured to send the first information to the drive unit through wired communication. The shifting device according to the eighth aspect sends the first information through wired communication in a preferred manner.

In accordance with a ninth aspect of the present disclosure, the shifting device according to any one of the first to eighth aspects is configured so that the shifting device is supplied with electric power from the drive unit. The shifting device according to the ninth aspect is actuated by electric power supplied from the drive unit.

In accordance with a tenth aspect of the present disclosure, the shifting device according to any one of the first to ninth aspects is configured so that the transmission device includes a derailleur. With the shifting device according to the tenth aspect, the derailleur shifts the transmission ratio in a preferred manner.

A drive unit in accordance with an eleventh aspect of the present disclosure is for the human-powered vehicle. The drive unit comprises a motor, a second controller and a third communicator. The motor is configured to apply a propulsion force to the human-powered vehicle. The second controller is configured to control the motor. The third communicator is configured to perform communication with a shifting device for a human-powered vehicle. The shifting device is configured to shift a transmission ratio of the human-powered vehicle. The second controller is configured to control the motor so that an assist level of the motor is changed in accordance with the first information in a case where the third communicator receives the first information from the shifting device. The first information includes at least one of information related to a shifting time of the transmission ratio and information related to a shifting period of the transmission ratio. The assist level is related to at least one of an upper limit value of an output of the motor, an assist ratio of the output of the motor to a human driving force input to the human-powered vehicle, and a response speed of the output of the motor to a change in the human driving force. The drive unit according to the eleventh aspect controls the assist level in a preferred manner in accordance with the first information, including at least one of the information related to the shifting time of the transmission ratio and the information related to the shifting period of the transmission ratio. The drive unit according to the eleventh aspect does not have to control the shifting device. This improves convenience for the user.

In accordance with a twelfth aspect of the present disclosure, the drive unit according to the eleventh aspect is configured so that the second controller is configured to control the motor so as to decrease the assist level of the motor in accordance with the first information in a case where the third communicator receives the first information from the shifting device. The drive unit according to the twelfth aspect decreases the assist level of the motor in accordance with the first information in a case where the drive unit receives the first information. This maintains shifting performance qualities.

In accordance with a thirteenth aspect of the present disclosure, the drive unit according to the twelfth aspect is configured so that the shifting time includes an initiation time for initiating shifting of the transmission ratio. The second controller is configured to control the motor so as to initiate decreasing of the assist level at the initiation time. The drive unit according to the thirteenth aspect controls the motor in a preferred manner such that the assist level is decreased at the initiation time included in the first information.

In accordance with a fourteenth aspect of the present disclosure, the drive unit according to any one of the eleventh to thirteenth aspects is configured so that the shifting period includes a predetermined shifting period from initiation of shifting of the transmission ratio to completion of shifting of the transmission ratio. The second controller is configured to control the motor so as to decrease the assist level in the predetermined shifting period. The drive unit according to the fourteenth aspect controls the motor in a preferred manner such that the assist level is decreased in the predetermined shifting period.

In accordance with a fifteenth aspect of the present disclosure, the drive unit according to any one of the eleventh to fourteenth aspects is configured so that the third communicator is configured to receive the first information through wired communication. The drive unit according to the fifteenth aspect receives the first information through wired communication in a preferred manner.

In accordance with a sixteenth aspect of the present disclosure, the drive unit according to any one of the eleventh to fifteenth aspects is configured so that the drive unit is configured to supply the shifting device with electric power. The drive unit according to the sixteenth aspect supplies electric power to the shifting device.

A control system in accordance with a seventeenth aspect of the present disclosure is for a human-powered vehicle. The control system comprises the shifting device according to any one of the first to tenth aspects and a drive unit. The drive unit includes a motor configured to apply a propulsion force to the human-powered vehicle, a second controller configured to control the motor, and a third communicator configured to perform communication with the shifting device. The second controller is configured to control the motor so as to change an assist level of the motor in accordance with the first information. The assist level is related to at least one of an output of the motor, an upper limit value of the output of the motor, an assist ratio of the output of the motor to a human driving force input to the human-powered vehicle, and a response speed of the output of the motor to a change in the human driving force. With the control system according to the seventeenth aspect, the drive unit controls the assist level in a preferred manner in accordance with the first information, including at least one of the information related to the shifting time of the transmission ratio and the information related to the shifting period of the transmission ratio. With the control system according to the seventeenth aspect, the drive unit does not have to control the shifting device. This improves convenience for the user.

A communication device in accordance with an eighteenth aspect of the present disclosure is for a human-powered vehicle. The human-powered vehicle includes a transmission device configured to shift a transmission ratio and a drive unit including a motor configured to apply a propulsion force to the human-powered vehicle. The communication device comprises a fourth communicator, configured to perform communication with the drive unit, and a third controller configured to control the fourth communicator so that the fourth communicator sends first information to the drive unit in a case where the transmission device shifts the transmission ratio, the first information. The first information includes at least one of information related to a shifting time of the transmission ratio and information related to a shifting period of the transmission ratio, to the drive unit. The communication device according to the eighteenth aspect sends the first information, including at least one of the information related to the shifting time of the transmission ratio and the information related to the shifting period of the transmission ratio, to the drive unit. Thus, the drive unit performs control in accordance with the first information. In this case, the drive unit does not have to control the shifting device. This improves convenience for the user.

In accordance with a nineteenth aspect of the present disclosure, the communication device according to the eighteenth aspect is configured so that the third controller is configured to control the transmission device. With the communication device according to the nineteenth aspect, the third controller included in the communication device controls the transmission device.

In accordance with a twentieth aspect of the present disclosure, the communication device according to the eighteenth or nineteenth aspect further comprises a power receiver and a power transmitter. The power receiver is configured to receive electric power from the drive unit. The power transmitter is configured to transmit the electric power received by the power reception unit to the transmission device. With the communication device according to the twentieth aspect, the transmission device is actuated by electric power supplied from the drive unit.

The shifting device, the drive unit, the control system , and the communication device according to the present disclosure improve convenience for the user.

### BRIEF DESCRIPTION OF THE DRAWINGS

Referring now to the attached drawings which form a part of this original disclosure, selected embodiments are illustrated.

FIG. 1 is a side elevational view of a human-powered vehicle including a human-powered vehicle shifting device, a human-powered vehicle drive unit, a human-powered vehicle control system, and a human-powered vehicle communication device in accordance with an embodiment.

FIG. 2 is a perspective view of a portion of the human-powered vehicle in FIG. 1 showing the human-powered vehicle drive unit and the human-powered vehicle communication device.

FIG. 3 is a block diagram showing the electrical configuration of the human-powered vehicle control system shown in FIG. 1.

FIG. 4 is a flowchart illustrating a control process executed by a first controller shown in FIG. 2 to control a shifting unit (i.e., a transmission device).

FIG. 5 is a flowchart illustrating a control process executed by a shifting controller shown in FIG. 2 to control the shifting unit.

FIG. 6 is a flowchart illustrating a control process executed by a second controller shown in FIG. 2 to control a motor.

FIG. 7 is a block diagram showing the electrical configuration of a human-powered vehicle control system in a modification.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

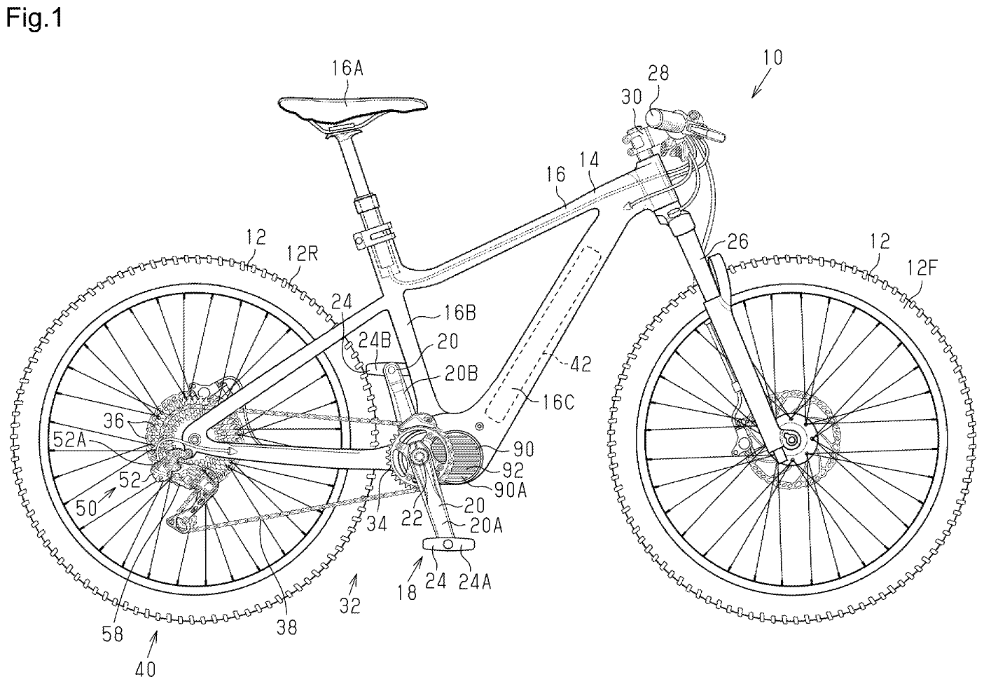

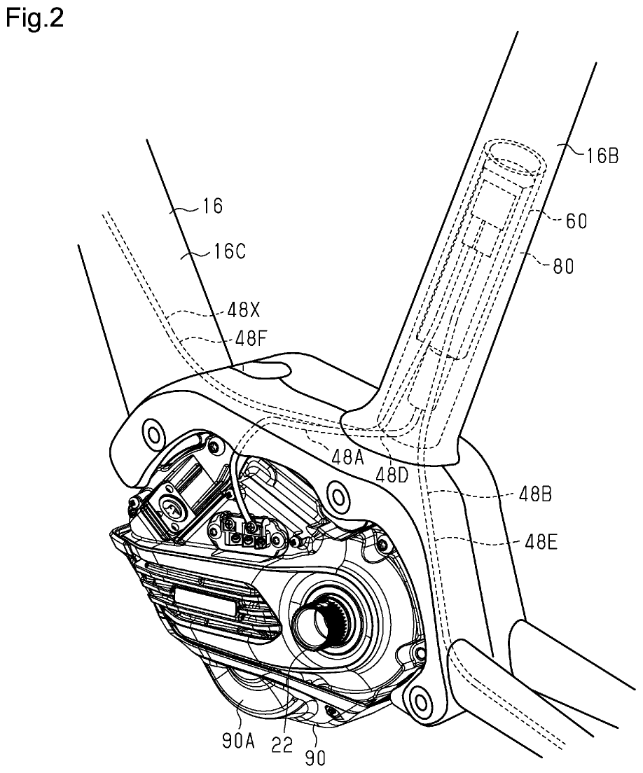

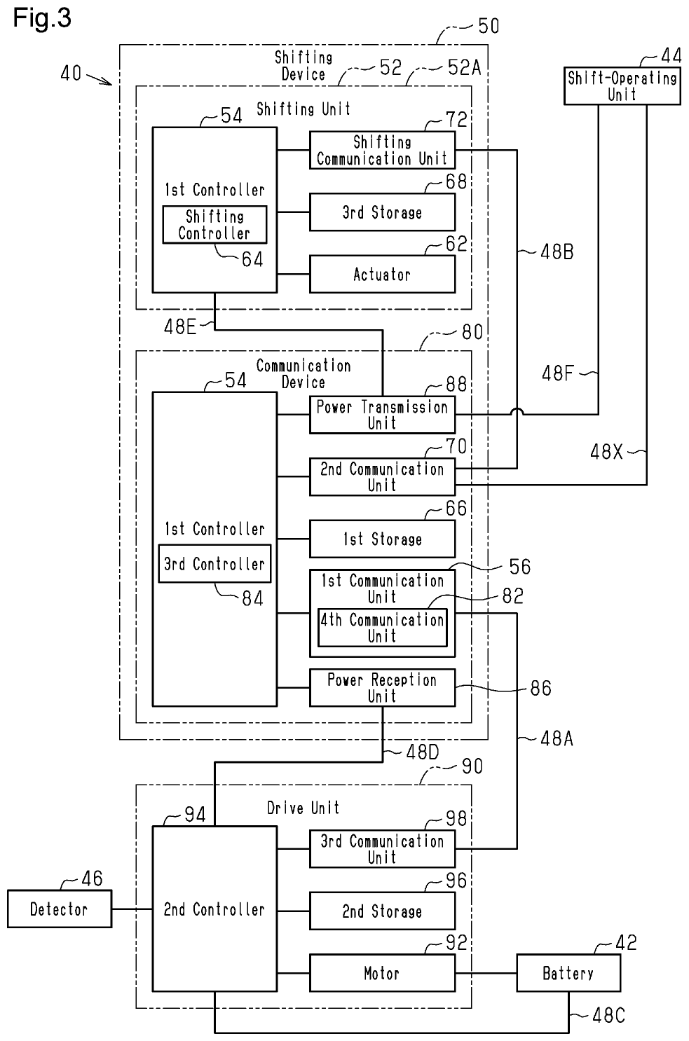

As shown in FIG. 1, a human-powered vehicle 10 is illustrated that is equipped with a control system 40, a shifting device 50, a communication device 80 and a drive unit 90. A first embodiment of the control system 40, the shifting device 50, the communication device 80 and the drive unit 90 will now be described with reference to FIGS. 1 to 6. The human-powered vehicle 10 is a vehicle that has at least one wheel and can be driven by at least a human driving force. In the embodiment described hereafter, the human-powered vehicle 10 is not limited to the illustrated example. Examples of human-powered vehicles that can be used include various types of bicycles such as a mountain bike, a road bike, a city bike, a cargo bike, a handcycle, and a recumbent bike. There is no limit to the number of wheels of the human-powered vehicle. The human-powered vehicle also includes, for example, a unicycle or a vehicle having two or more wheels. The human-powered vehicle is not limited to a vehicle that can be driven only by a human driving force. The human-powered vehicle includes an electric bicycle (E-bike) that uses a drive force of an electric motor for propulsion in addition to a human driving force. The E-bike includes an electric assist bicycle that assists in propulsion with an electric motor. In the embodiment described hereafter, the human-powered vehicle 10 will be described as a bicycle.

The human-powered vehicle 10 includes at least one wheel 12 and a vehicle body 14. The at least one wheel 12 includes, for example, a front wheel 12F and a rear wheel 12R. The vehicle body 14 includes a frame 16. For example, a saddle 16A is attached to the frame 16.

The human-powered vehicle 10 further includes, for example, a crank 18 to which the human driving force is input. The crank 18 includes, for example, crank arms 20 and a crank axle 22. The crank axle 22 is rotatable relative to, for example, the frame 16. For example, pedals 24 are coupled to the crank arms 20. The crank arms 20 include, for example, a first crank arm 20A and a second crank arm 20B. The pedals 24 include, for example, a first pedal 24A and a second pedal 24B.

The first crank arm 20A and the second crank arm 20B are provided on, for example, two axial ends of the crank axle 22, respectively. For example, the first pedal 24A is coupled to the first crank arm 20A. For example, the second pedal 24B is coupled to the second crank arm 20B.

A front fork 26 is connected to the frame 16. The front wheel 12F is attached to the front fork 26. A handlebar 28 is coupled to the front fork 26 by a stem 30. The rear wheel 12R is supported by the frame 16. In the present embodiment, the crank 18 is connected to the rear wheel 12R by a drive mechanism 32. The rear wheel 12R is driven by the rotation of the crank axle 22. At least one of the front wheel 12F and the rear wheel 12R can be connected to the crank 18 by the drive mechanism 32.

The drive mechanism 32 includes at least one first rotational body 34 coupled to the crank axle 22. The at least one first rotational body 34 includes, for example, a front sprocket. The at least one first rotational body 34 can include a pulley or a bevel gear. The crank axle 22 can be coupled to the front sprocket by a one-way clutch.

The drive mechanism 32 further includes at least one second rotational body 36 and a transferring member 38. The transferring member 38 is configured to transfer the rotational force of the at least one first rotational body 34 to the at least one second rotational body 36. The transferring member 38 includes, for example, a chain. The transferring member 38 can include a belt or a shaft. The at least one second rotational body 36 includes, for example, a rear sprocket. The at least one second rotational body 36 can include a pulley or a bevel gear. The chain is wound around, for example, the front sprocket and the rear sprocket. The at least one second rotational body 36 is coupled to, for example, the rear wheel 12R. For example, the rear wheel 12R is configured to rotate as the at least one second rotational body 36 rotates.

The human-powered vehicle 10 includes, for example, a shifting unit 52 and the drive unit 90 for a human-powered vehicle. The shifting unit 52 is configured to shift a transmission ratio. Thus, the shifting unit 52 can be referred to as a transmission device. The drive unit 90 includes a motor 92 configured to apply propulsion force to the human-powered vehicle 10. The control system 40 for a human-powered vehicle includes the shifting device 50 for a human-powered vehicle and the drive unit 90 for a human-powered vehicle.

The control system 40 further includes, for example, a battery 42. The battery 42 includes, for example, one or more battery cells. Each battery cell includes, for example, a rechargeable battery. The battery 42 is provided on, for example, the frame 16. The battery 42 supplies electric power to, for example, the drive unit 90.

The shifting device 50 includes the shifting unit 52 (the transmission device) configured to shift a transmission ratio of the human-powered vehicle 10, a first controller 54, and a first communication unit 56. The term “communication unit” as used herein refers to a hardware device or hardware devices, and does not include a human being. The first communication unit 56 can also be referred to as a first communicator. The shifting unit 52 (the transmission device) further includes, for example, a shifting housing 58. The shifting device 50 further includes, for example, the communication device 80. The shifting device 50 further includes, for example, a communication housing 60 provided with the first communication unit 56 and formed separately from the shifting unit 52. The communication device 80 includes, for example, the communication housing 60.

The communication housing 60 is provided on, for example, the vehicle body 14 at a position separated from the shifting housing 58. The shifting unit 52 is provided on, for example, the axle of the wheel 12 or in the vicinity of the axle. The communication device 80 is provided on, for example, the frame 16. For example, the communication device 80 is located closer to the drive unit 90 than the shifting unit 52. The communication device 80 is provided on, for example, a seat tube 16B or a down tube 16C of the frame 16. The communication housing 60 is, for example, cylindrical. For example, the communication housing 60 is sized to be arrangeable in the interior cavity of the frame 16. The communication device 80 is provided in, for example, the interior cavity of the frame 16.

The shifting unit 52 (the transmission device) includes, for example, a derailleur 52A. In the present embodiment, the derailleur 52A includes a rear derailleur. The derailleur 52A can include a front derailleur. For example, the derailleur 52A is provided in a transmission path of the human driving force in the human-powered vehicle 10 and is configured to shift a transmission ratio. The transmission ratio is, for example, a ratio of a rotational speed of the at least one wheel 12 to a rotational speed of the crank axle 22. The rotational speed of the at least one wheel 12 includes, for example, the rotational speed of the drive wheel. The drive wheel includes, for example, the rear wheel 12R. The drive wheel can include the front wheel 12F. The shifting unit 52 can include an internal transmission device.

The shifting unit 52 (the transmission device) includes, for example, an actuator 62. The actuator 62 includes, for example, an electric motor. For example, the actuator 62 is configured to actuate the derailleur 52A. The shifting device 50 further includes, for example, the at least one second rotational body 36 and the transferring member 38. The at least one second rotational body 36 includes a plurality of second rotational bodies 36. The derailleur 52A shifts the transmission ratio by moving the transferring member 38 from one of the second rotational bodies 36 to another one of the second rotational bodies 36. The relationship of the transmission ratio, the rotational speed of the at least one wheel 12, and the rotational speed of the crank axle 22 satisfies Equation (1), which is set forth below. In Equation (1), the term “R” represents the transmission ratio. In Equation (1), the term “W” represents the rotational speed of the drive wheel. In Equation (1), the term “C” represents the rotational speed of the crank axle 22.

R=W(rpm)/C(rpm) Equation (1)

The shifting housing 58 is, for example, integrated with the derailleur 52A. The actuator 62 is provided on, for example, the derailleur 52A.

The first controller 54 includes, for example, processors that execute predetermined control programs. The processors include, for example, a central processing unit (CPU) or a micro-processing unit (MPU). The first controller 54 can include one or more microcomputers. Thus, the first controller 54 is formed of one or more semiconductor chips that are mounted on a circuit board. The first controller 54 can include a plurality of processors located at separate positions. The first controller 54 is provided in, for example, the shifting housing 58 and the communication housing 60. The term “controller” as used herein refers to hardware that executes a software program, and does not include a human being. Accordingly, the first controller 54 can be referred to as a first electronic controller or merely as an electronic controller.

The shifting device 50 includes, for example, a shifting controller 64. The shifting controller 64 includes, for example, processors that execute predetermined control programs. The processors include, for example, a CPU or an MPU. The shifting controller 64 can include one or more microcomputers. The shifting controller 64 can include a plurality of processors located at separate positions. The shifting controller 64 is provided in, for example, the shifting housing 58. For example, the first controller 54 includes the shifting controller 64. The shifting controller 64 can be referred to as an electronic shifting controller or merely as an electronic controller.

The shifting device 50 further includes, for example, a first storage 66. The first storage 66 stores, for example, control programs and information used for control processes. The first storage 66 includes, for example, at least one of a non-volatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM). For example, the first storage 66 is connected to the first controller 54 in a manner allowing for wired communication or wireless communication. The first storage 66 is provided in, for example, the communication housing 60. At least part of the first storage 66 can be provided in the shifting housing 58. Thus, the first storage 66 can be any computer storage device or any non-transitory computer-readable medium with the sole exception of a transitory, propagating signal.

The shifting device 50 further includes, for example, a third storage 68. The third storage 68 stores, for example, control programs and information used for control processes. The third storage 68 includes, for example, at least one of a non-volatile memory and a volatile memory. The non-volatile memory includes, for example, at least one of a ROM, an EPROM, an EEPROM, and a flash memory. The volatile memory includes, for example, a RAM. For example, the third storage 68 is connected to the shifting controller 64 in a manner allowing for wired communication or wireless communication. The third storage 68 is provided in, for example, the shifting housing 58. In a case where at least part of the first storage 66 is provided in the shifting housing 58, the first storage 66 can include the third storage 68. Thus, the third storage 68 can be any computer storage device or any non-transitory computer-readable medium with the sole exception of a transitory, propagating signal.

The communication device 80 includes, for example, a fourth communication unit 82 and a third controller 84. The fourth communication unit 82 is configured to perform communication with the drive unit 90. The fourth communication unit 82 can also be referred to as a fourth communicator. The third controller 84 includes, for example, processors that execute predetermined control programs. The processors include, for example, a CPU or an MPU. The third controller 84 can include one or more microcomputers. The third controller 84 can include a plurality of processors located at separate positions. The third controller 84 is provided in, for example, the communication housing 60. For example, the first controller 54 includes the third controller 84. The third controller 84 can be referred to as a third electronic controller or merely as an electronic controller.

The drive unit 90 includes, for example, the motor 92 configured to apply a propulsion force to the human-powered vehicle 10. The drive unit 90 further includes, for example, a housing 90A in which the motor 92 is provided. The drive unit 90 is provided on, for example, the crank axle 22. The drive unit 90 can be a hub motor provided on the at least one wheel 12.

The drive unit 90 further includes, for example, a second controller 94. The second controller 94 includes, for example, processors that execute predetermined control programs. The processors include, for example, a central processing unit (CPU) or a micro-processing unit (MPU). The second controller 94 can include one or more microcomputers. The second controller 94 can include a plurality of processors located at separate positions. The second controller 94 can be referred to as a second electronic controller or merely as an electronic controller.

The drive unit 90 further includes, for example, a second storage 96. The second storage 96 stores, for example, control programs and information used for control processes. The second storage 96 includes, for example, at least one of a non-volatile memory and a volatile memory. The non-volatile memory includes, for example, at least one of a ROM, an EPROM, an EEPROM, and a flash memory. The volatile memory includes, for example, a RAM. For example, the second storage 96 is connected to the second controller 94 in a manner allowing for wired communication or wireless communication. The second storage 96 is provided in, for example, the housing 90A of the drive unit 90. Thus, the second storage 96 can be any computer storage device or any non-transitory computer-readable medium with the sole exception of a transitory, propagating signal.

The second controller 94 is, for example, configured to control the motor 92. The drive unit 90 can further include a drive circuit of the motor 92. The second controller 94 and the drive circuit are provided in, for example, the housing 90A of the drive unit 90. The second controller 94 and the drive circuit can be provided on the same circuit board. For example, the drive circuit is connected to the second controller 94 in a manner allowing for wired communication or wireless communication. For example, the drive circuit drives the motor 92 in accordance with a control signal from the second controller 94.

The drive circuit is, for example, electrically connected to the motor 92. For example, the drive circuit controls the supply of electric power from the battery 42 to the motor 92. The drive circuit includes, for example, an inverter circuit. The inverter circuit includes, for example, a plurality of transistors. For example, the inverter circuit has a configuration in which inverter units are connected in parallel and each inverter unit is formed by two transistors connected in series.

The second controller 94 is, for example, configured to control the motor 92 in accordance with at least one of the rotational speed of the crank axle 22 and the rotational speed of the first rotational body 34 detected by a crank rotational state detector. For example, the second controller 94 is configured to control the motor 92 in accordance with the speed of the human-powered vehicle 10 detected by a vehicle speed detector.

The second controller 94 is, for example, configured to drive the motor 92 so as to apply a propulsion force to the human-powered vehicle 10 in accordance with at least one of the human driving force and the rotational speed of the crank axle 22 in a case where the speed of the human-powered vehicle 10 is less than a predetermined vehicle speed. For example, the predetermined vehicle speed is specified by regulations of each country. For example, the predetermined vehicle speed is 24 km/h, 25 km/h, 30 km/h, 32 km/h, or 45 km/h.

The second controller 94 is, for example, configured to control the motor 92 so that an assist level of the motor 92 is a predetermined assist level. The assist level is related to, for example, at least one of output of the motor 92, an upper limit value of the output of the motor 92, an assist ratio of the output of the motor 92 to the human driving force input to the human-powered vehicle 10, and response speed of the output of the motor 92 to a change in the human driving force. The response speed includes at least one of a first response speed in a case where the human driving force increases and a second response speed in a case where the human driving force decreases. For example, the second controller 94 is configured to control the motor 92 so that a ratio of the assist force to the human driving force is a predetermined ratio. The output of the motor 92, the upper limit value of the output of the motor 92, the assist ratio, and the first response speed decrease as the assist level decreases. The second response speed increases as the assist level decreases.

The human driving force is expressed in, for example, at least one of torque and power. In a case where the human driving force is expressed in torque, for example, the human driving force is referred to as human torque. In a case where the human driving force is expressed in power, for example, the human driving force is referred to as human force-based power. For example, the human force-based power is the product of the torque applied to the crank axle 22 and the rotational speed of the crank axle 22.

The assist force is expressed in, for example, at least one of torque and power. In a case where the assist force is expressed in torque, for example, the assist force is referred to as assist torque. In a case where the assist force is expressed in power, for example, the assist force is referred to as assist force-based power. The ratio of the assist force to the human driving force can be a ratio of the assist torque to the human torque or a ratio of the assist force-based power to the human force-based power.

The first communication unit 56 is configured to perform communication with the drive unit 90. For example, the first communication unit 56 is configured to send various types of information through wired communication. The drive unit 90 includes, for example, a third communication unit 98 configured to perform communication with the shifting device 50. For example, the third communication unit 98 is configured to receive various types of information through wired communication. The third communication unit 98 can also be referred to as a third communicator. The first communication unit 56 is provided in, for example, the communication housing 60. For example, the communication device 80 includes the first communication unit 56.

The control system 40 further includes, for example, a shift-operating unit 44. The shift-operating unit 44 is provided on, for example, the handlebar 28. The shift-operating unit 44 includes, for example, at least one of a lever, a switch, and a dial. Thus, the shift-operating unit 44 can be referred to as a user operating device or a shifter. The shifting device 50 further includes, for example, a second communication unit 70 configured to receive a shifting signal for shifting the transmission ratio from the shift-operating unit 44. The shifting signal includes, for example, a first shifting signal for increasing the transmission ratio and a second shifting signal for decreasing the transmission ratio. The second communication unit 70 can also be referred to as a second communicator.

The shifting unit 52 further includes, for example, a shifting communication unit 72. For example, the shifting communication unit 72 is configured to perform communication with the communication device 80. For example, the shifting communication unit 72 is configured to perform communication with the third controller 84. The shifting communication unit 72 can also be referred to as a shifting communicator.

The control system 40 further includes, for example, a detector 46. The term “detector” as used herein refers to a hardware device or instrument designed to detect the presence or absence of a particular event, object, substance, or a change in its environment, and to emit a signal in response. The term “detector” as used herein do not include a human being. The detector 46 detects, for example, a parameter related to control of the shifting unit 52. The detector 46 includes, for example, a second rotational body state detector. The second rotational body state detector detects, for example, a rotational phase of the second rotational body 36. The detector 46 can include at least one of a crank rotational state detector, a human driving force detector, a vehicle speed detector, and an inclination detector that detects an inclination angle of the human-powered vehicle 10. For example, the detector 46 is configured to perform communication with the drive unit 90. At least part of the detector 46 can be configured to perform communication with the shifting device 50 without using the drive unit 90. For example, at least part of the detector 46 can be configured to perform communication with at least one of the shifting unit 52 and the communication device 80 without using the drive unit 90.

The control system 40 further includes, for example, a first communication cable 48A that connects the first communication unit 56 and the third communication unit 98. The first communication cable 48A is attachable to and detachable from, for example, at least one of the first communication unit 56 and the third communication unit 98.

The control system 40 further includes, for example, a second communication cable 48B that connects the second communication unit 70 and the shifting communication unit 72. The second communication cable 48B is attachable to and detachable from, for example, at least one of the second communication unit 70 and the shifting communication unit 72. The control system 40 further includes, for example, a fourth communication cable 48X that connects the second communication unit 70 and the shift-operating unit 44. The fourth communication cable 48X is attachable to and detachable from, for example, at least one of the second communication unit 70 and the shift-operating unit 44.

A first communication protocol between the first communication unit 56 and the third communication unit 98 differs from a second communication protocol between the second communication unit 70 and the shift-operating unit 44. The first communication protocol can be the same as the second communication protocol. The first communication protocol includes, for example, at least one of power line communication (PLC), Controller Area Network (CAN), and universal asynchronous receiver-transmitter (UART). The second communication protocol includes at least one of power line communication, CAN, and UART.

In an example, the drive unit 90 supplies electric power to the shifting device 50. For example, the shifting device 50 is supplied with electric power from the drive unit 90. For example, the shifting device 50 is supplied with electric power from the battery 42 via the drive unit 90. For example, the electric power of the battery 42 is supplied to the communication device 80. For example, the electric power of the battery 42 is supplied to the shifting unit 52 from the communication device 80. The communication device 80 further includes, for example, a power reception unit 86 and a power transmission unit 88. The power reception unit 86 receives electric power from the drive unit 90. The power transmission unit 88 transmits the electric power received by the power reception unit 86 to the shifting unit 52. The power reception unit 86 can be referred to as a power receiver and the power transmission unit 88 can be referred to as a power transmitter.

The control system 40 further includes, for example, a first electric power cable 48C that connects the battery 42 and the drive unit 90. The first electric power cable 48C is attachable to and detachable from, for example, at least one of the battery 42 and the drive unit 90. The first electric power cable 48C includes, for example, an electric power line that supplies electric power from the battery 42 to the drive unit 90.

The control system 40 further includes, for example, a second electric power cable 48D that connects the power reception unit 86 and the drive unit 90. The second electric power cable 48D is attachable to and detachable from, for example, at least one of the power reception unit 86 and the drive unit 90. The second electric power cable 48D includes, for example, an electric power line that supplies electric power from the drive unit 90 to the power reception unit 86. The first electric power cable 48C and the second electric power cable 48D are, for example, formed by a single cable including multiple core wires.

The control system 40 further includes, for example, a third electric power cable 48E that connects the power transmission unit 88 and the shifting unit 52. The third electric power cable 48E is attachable to and detachable from, for example, at least one of the power transmission unit 88 and the shifting unit 52. The third electric power cable 48E includes, for example, an electric power line that supplies electric power from the power transmission unit 88 to the shifting unit 52. The second communication cable 48B and the third electric power cable 48E are formed by, for example, a single cable including multiple core wires. The control system 40 further includes, for example, a fourth electric power cable 48F that connects the power transmission unit 88 and the shift-operating unit 44. The fourth communication cable 48X and the fourth electric power cable 48F are formed by, for example, a single cable including multiple core wires.

In a case where the first communication protocol includes power line communication, the second communication cable 48B can perform the electric power transmission from the communication device 80 to the shifting unit 52 and the communication between the communication device 80 and the shifting unit 52. In a case where the second communication protocol includes power line communication, the first communication cable 48A can perform the electric power transmission from the drive unit 90 to the communication device 80 and the communication between the communication device 80 and the drive unit 90.

In an example, the communication device 80 is configured to perform communication with the shifting unit 52 through power line communication, the communication device 80 is configured to perform communication with the drive unit 90 through CAN or UART, and the battery 42 is configured to perform communication with the drive unit 90 through CAN or UART.

The first controller 54 is configured to control the shifting unit 52. For example, the third controller 84 is configured to control the shifting unit 52. The first controller 54 controls the shifting unit 52, for example, by sending a shifting initiation signal to the shifting unit 52. For example, the third controller 84 is configured to send a shifting initiation signal to the shifting controller 64. For example, in a case where the shifting controller 64 receives a shifting initiation signal from the third controller 84, the shifting controller 64 actuates the actuator 62.

The first controller 54 is, for example, configured to determine at least one of a shifting time and a shifting period in accordance with at least one of the transmission ratio prior to shifting and the transmission ratio subsequent to shifting. The shifting time includes, for example, an initiation time for initiating shifting of the transmission ratio. The shifting period includes, for example, a predetermined shifting period from initiation of shifting of the transmission ratio to completion of the shifting of the transmission ratio. For example, in a case where a shifting signal is received, after a predetermined period elapses, the first controller 54 is configured to control the shifting unit 52 so that the shifting unit 52 initiates shifting of the transmission ratio at an initiation time. For example, in a case where a shifting signal is received, after the predetermined period elapses, the first controller 54 sends a shifting initiation signal for initiating shifting of the transmission ratio at an initiation time to the shifting controller 64.

The first controller 54 can be configured to control the shifting unit 52 in accordance with a shifting signal sent from the drive unit 90. For example, the second controller 94 generates a shifting signal in accordance with at least one of a traveling state and a traveling environment of the human-powered vehicle 10 and sends the generated shifting signal to the first controller 54. The at least one of the traveling state and the traveling environment of the human-powered vehicle 10 includes, for example, at least one of rotational speed of the crank axle 22, human driving force, vehicle speed, gradient, and traveling resistance.

The predetermined period is specified by, for example, time. The predetermined period can be specified by at least one of a rotational amount of the second rotational body 36 and a rotational amount of the crank axle 22. At least one of the rotational amount of the second rotational body 36 and the rotational amount of the crank axle 22 is obtained from, for example, the detector 46. The predetermined period can be determined based on the rotational phase of the second rotational body 36. In a case where the second rotational body 36 includes a shifting facilitation region, the predetermined period can be a period until the rotational phase of the second rotational body 36 reaches a phase at which the transferring member 38 corresponds to the shifting facilitation region.

The shifting period is, for example, a period sufficient for the derailleur 52A to complete shifting of the transmission ratio. The shifting period is, for example, a period from initiation of actuation of the derailleur 52A to completion of shifting of the transmission ratio. The shifting period can be stored in the first storage 66. For example, the first controller 54 stops the actuator 62 in a case where the shifting period elapses from a point of time at which the actuator 62 is actuated.

In a case where the detector 46 is configured to perform communication with the drive unit 90, the first controller 54 can determine at least one of the predetermined period and the shifting period based on a detection result of the detector 46 obtained from the drive unit 90.

In a case where the first controller 54 controls the shifting unit 52, the first controller 54 sends first information to the drive unit 90. For example, the first communication unit 56 is configured to send the first information through wire communication. For example, the third communication unit 98 is configured to receive the first information through wire communication.

In a case where the first controller 54 shifts the transmission ratio, for example, the first controller 54 is configured to control the first communication unit 56 so that the first communication unit 56 sends the first information to the drive unit 90. In a case where the shifting unit 52 shifts the transmission ratio, for example, the third controller 84 is configured to control the fourth communication unit 82 so that the fourth communication unit 82 sends the first information to the drive unit 90. In a case where the second communication unit 70 receives a shifting signal, for example, the first controller 54 is configured to control the first communication unit 56 so that the first communication unit 56 sends the first information to the drive unit 90. In a case where the drive unit 90 is configured to send a shifting signal and if the first communication unit 56 receives a shifting signal, for example, the first controller 54 can be configured to control the first communication unit 56 so that the first communication unit 56 sends the first information to the drive unit 90.

The first information includes, for example, at least one of information related to the shifting time of the transmission ratio and information related to the shifting period of the transmission ratio. The first information includes at least one of the initiation time and the predetermined period.

The second controller 94 is configured to control the motor 92 so as to change the assist level of the motor 92 in accordance with the first information. For example, the second controller 94 can be configured to set the assist level to a first assist level in accordance with the first information. At the first assist level, the output of the motor 92 is, for example, zero.

In a case where the third communication unit 98 receives the first information from the shifting device 50, for example, the second controller 94 is configured to control the motor 92 so as to change the assist level of the motor 92 in accordance with the first information. For example, the second controller 94 is configured to control the motor 92 so as to initiate decreasing of the assist level at the initiation time. For example, the second controller 94 is configured to control the motor 92 so as to decrease the assist level in the predetermined shifting period.

The second controller 94 is, for example, configured to control the motor 92 so that the assist level is decreased in accordance with the first information over a period from a point of time at which the shifting unit 52 initiates shifting of the transmission ratio to a point of time at which the shifting unit 52 completes the shifting of the transmission ratio. For example, the second controller 94 is configured to control the motor 92 so that the motor 92 is stopped in accordance with the first information over a period from a point of time at which the shifting unit 52 initiates shifting of the transmission ratio to a point of time at which the shifting unit 52 completes the shifting of the transmission ratio.

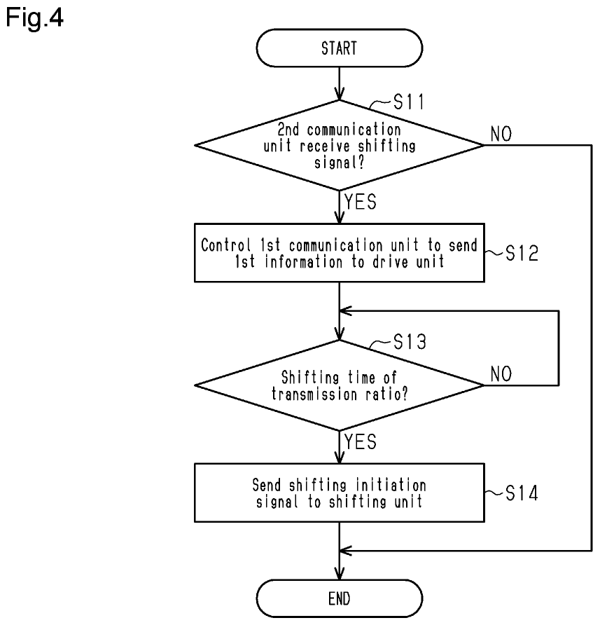

A process executed by the first controller 54 to control the shifting unit 52 will now be described with reference to FIG. 4. For example, in a case where electric power is supplied to the first controller 54, the first controller 54 starts the process of the flowchart shown in FIG. 4 from step S11. In a case where the process of the flowchart shown in FIG. 4 ends, the first controller 54 repeats the process from step S11 in predetermined cycles, for example, until the supply of electric power stops.

In step S11, the first controller 54 determines whether the second communication unit 70 receives a shifting signal. In a case where the second communication unit 70 does not receive a shifting signal, the first controller 54 ends processing. In a case where the second communication unit 70 has received a shifting signal, the first controller 54 proceeds to step S12. In step S12, the first controller 54 controls the first communication unit 56 so that the first communication unit 56 sends the first information to the drive unit 90. Then, the first controller 54 proceeds to step S13.

In step S13, the first controller 54 determines whether it is the shifting time of the transmission ratio. In a case where it is not the shifting time of the transmission ratio, the first controller 54 executes step S13 again. In a case where it is the shifting time of the transmission ratio, the first controller 54 proceeds to step S14. In step S14, the first controller 54 sends a shifting initiation signal to the shifting unit 52, and then ends processing. The shifting initiation signal includes, for example, information related to the shifting period.

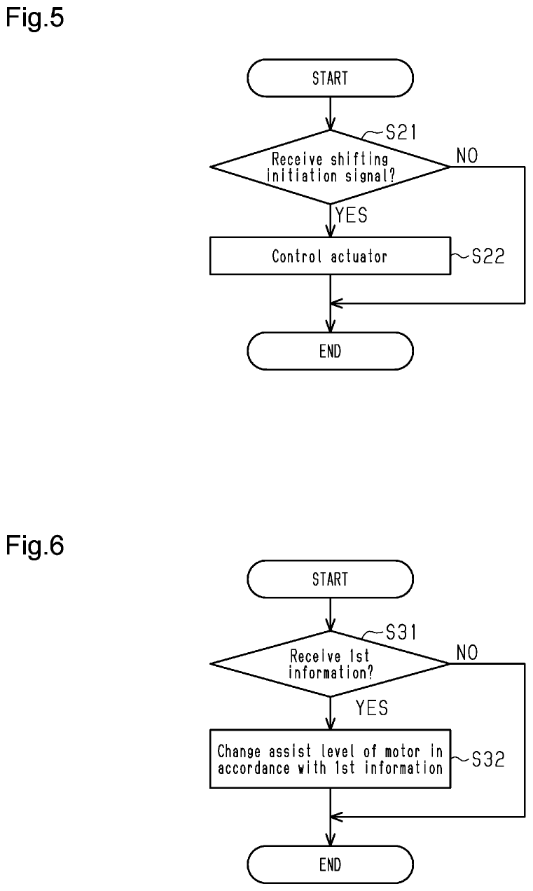

A process executed by the shifting controller 64 to perform a shifting action will now be described with reference to FIG. 5. For example, in a case where electric power is supplied to the shifting controller 64, the shifting controller 64 starts the process of the flowchart shown in FIG. 5 from step S21. In a case where the process of the flowchart shown in FIG. 5 ends, the shifting controller 64 repeats the process from step S21 in predetermined cycles, for example, until the supply of electric power stops.

In step S21, the shifting controller 64 determines whether the shifting controller 64 receives a shifting initiation signal. In a case where the shifting controller 64 does not receive a shifting initiation signal, the shifting controller 64 ends processing. In a case where the shifting controller 64 has received a shifting initiation signal, the shifting controller 64 proceeds to step S22.

In step S22, the shifting controller 64 controls the actuator 62 and then ends processing. For example, the shifting controller 64 continues to operate the actuator 62 until the shifting period elapses in step S22.

A process executed by the second controller 94 to change the assist level will now be described with reference to FIG. 6. For example, in a case where electric power is supplied to the second controller 94, the second controller 94 starts the process of the flowchart shown in FIG. 6 from step S31. In a case where the process of the flowchart shown in FIG. 6 ends, the second controller 94 repeats the process from step S31 in predetermined cycles, for example, until the supply of electric power stops.

In step S31, the second controller 94 determines whether the second controller 94 receives the first information. In a case where the second controller 94 does not receive the first information, the second controller 94 ends processing. In a case where the second controller 94 has received the first information, the second controller 94 proceeds to step S32. In step S32, the second controller 94 changes the assist level of the motor 92 in accordance with the first information. Then, the second controller 94 ends processing.

In a case where the motor 92 is operating in step S32, for example, the second controller 94 stops the motor 92 for a period corresponding to the shifting period. The period corresponding to the shifting period is, for example, a period from a point of time at which the shifting unit 52 initiates actuation to a point of time at which the shifting unit 52 ends the actuation. The period corresponding to the shifting period does not have to be equal to the period from a point of time at which the shifting unit 52 initiates actuation to a point of time at which the shifting unit 52 ends the actuation. For example, the second controller 94 can change the assist level of the motor 92 after the shifting unit 52 initiates actuation. For example, the second controller 94 can return the assist level of the motor 92 before the shifting unit 52 completes the actuation. In a case where the motor 92 is not operating in step S32, for example, the second controller 94 drives the motor 92 after the period corresponding to the shifting period elapses. In a case where the motor 92 is not operating in step S32, for example, the second controller 94 prohibits driving of the motor 92 for the period corresponding to the shifting period.

### Modifications

The description related with the above embodiment exemplifies, without any intention to limit, an applicable form of a shifting device for a human-powered vehicle, a drive unit for a human-powered vehicle, a control system for a human-powered vehicle, and a communication device for a human-powered vehicle in accordance with the present disclosure. The shifting device for a human-powered vehicle, the drive unit for a human-powered vehicle, the control system for a human-powered vehicle, and the communication device for a human-powered vehicle according to the present disclosure are applicable to, for example, modifications of the above embodiment that are described below and combinations of at least two of the modifications that do not contradict each other. In the modifications described hereafter, same reference numerals are given to those components that are the same as the corresponding components of the above embodiment. Such components will not be described in detail.

The third controller 84 can be configured to send the first information, instead of a shifting initiation signal, to the shifting controller 64. The shifting controller 64 controls the actuator 62 in accordance with the shifting time and the shifting period included in the first information. In a case where the third controller 84 is configured to send the first information to the shifting controller 64, steps S12, S13, and S14 in FIG. 4 can be omitted. In a case where steps S12, S13, and S14 in FIG. 4 are omitted and if the second communication unit 70 receives a shifting signal in step S11, the third controller 84 sends the first information to the drive unit 90 and the shifting controller 64. Then, the third controller 84 ends processing.

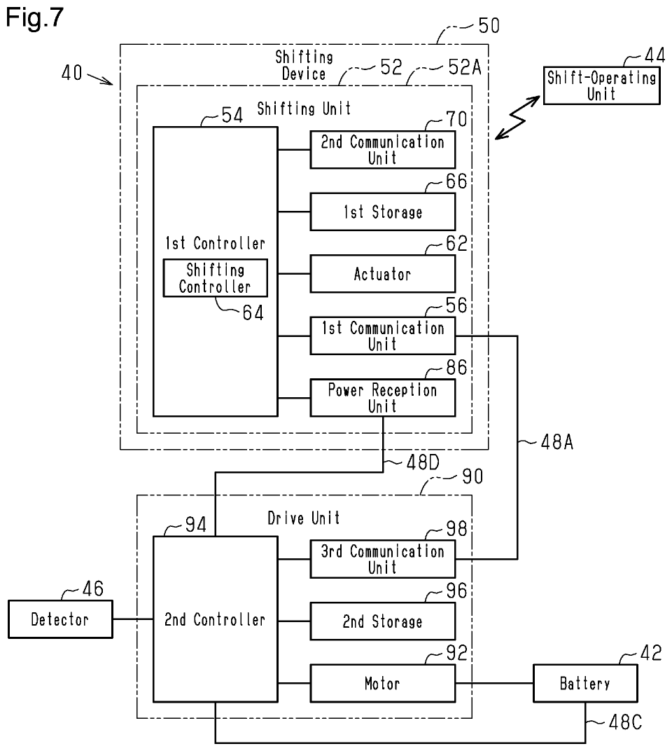

The communication device 80 can be omitted from the control system 40. For example, in the control system 40 shown in FIG. 7, the shifting unit 52 includes the first controller 54, the first communication unit 56, the second communication unit 70, the first storage 66, and the power reception unit 86.

The second communication unit 70 can be configured to receive a shifting signal through wireless communication. For example, in the control system 40 shown in FIG. 7, the shift-operating unit 44 and the second communication unit 70 are configured to perform wireless communication.

In a case where the third communication unit 98 receives the first information from the shifting device 50, the second controller 94 can increase the assist level of the motor 92 in accordance with the first information. Thus, the drive unit 90 does not need to have a configuration for obtaining the first information. This improves convenience for the user.

As long as the shifting device 50 is configured as described below, any other structure can be omitted. The shifting device 50 includes the shifting unit 52 configured to shift the transmission ratio of the human-powered vehicle 10, the first controller 54 configured to control the shifting unit 52, and the first communication unit 56 configured to perform communication with the drive unit 90 for a human-powered vehicle. The drive unit 90 includes the motor 92 configured to apply propulsion force to the human-powered vehicle 10. In a case where the first controller 54 shifts the transmission ratio, the first controller 54 is configured to control the first communication unit 56 so that the first communication unit 56 sends the first information, including at least one of information related to the shifting time of the transmission ratio and information related to the shifting period of the transmission ratio, to the drive unit 90.

As long as the drive unit 90 is configured as described below, any other structure can be omitted. The drive unit 90 includes the motor 92 configured to apply propulsion force to the human-powered vehicle 10, the second controller 94 configured to control the motor 92, and the third communication unit 98 configured to perform communication with the shifting device 50 for a human-powered vehicle. The shifting device 50 is configured to shift the transmission ratio of the human-powered vehicle 10. In a case where the third communication unit 98 receives the first information, including at least one of information related to the shifting time of the transmission ratio and information related to the shifting period of the transmission ratio, from the shifting device 50, the second controller 94 is configured to control the motor 92 so that the assist level of the motor 92 is changed in accordance with the first information. The assist level is related to at least one of the upper limit value of the output of the motor 92, the assist ratio of the output of the motor 92 to the human driving force input to the human-powered vehicle 10, and the response speed of the output of the motor 92 to a change in the human driving force.

As long as the control system 40 is configured as described below, any other structure can be omitted. The control system 40 includes the shifting device 50 and the drive unit 90. The drive unit 90 includes the motor 92 configured to apply propulsion force to the human-powered vehicle 10, the second controller 94 configured to control the motor 92, and the third communication unit 98 configured to perform communication with the shifting device 50. The second controller 94 is configured to control the motor 92 so as to change the assist level of the motor 92 in accordance with the first information. The assist level is related to at least one of the output of the motor 92, the upper limit value of the output of the motor 92, the assist ratio of the output of the motor 92 to the human driving force input to the human-powered vehicle 10, and the response speed of the output of the motor 92 to a change in the human driving force.

As long as the human-powered vehicle 10 and the communication device 80 are configured as described below, any other structure can be omitted. The human-powered vehicle 10 includes the shifting unit 52 configured to shift the transmission ratio and the drive unit 90 for a human-powered vehicle including the motor 92 configured to apply propulsion force to the human-powered vehicle 10. The communication device 80 includes the fourth communication unit 82, configured to perform communication with the drive unit 90, and the third controller 84. In a case where the shifting unit 52 shifts the transmission ratio, the third controller 84 is configured to control the fourth communication unit 82 so that the fourth communication unit 82 sends the first information, including at least one of information related to the shifting time of the transmission ratio and information related to the shifting period of the transmission ratio, to the drive unit 90.

The phrase “at least one of” as used in this disclosure means “one or more” of a desired choice. As one example, the phrase “at least one of” as used in this disclosure means “only one choice” or “both of two choices” in a case where the number of choices is two. In another example, the phrase “at least one of” as used in this disclosure means “only one single choice” or “any combination of two or more choices” if the number of its choices is three or more.

Ordinal numerals such as “first”, “second”, and “third” as used in this specification are only to differentiate multiple members having the same name and these words have no special meaning.

What is claimed is:

1. A shifting device for a human-powered vehicle, the shifting device comprising:
a transmission device configured to shift a transmission ratio of the human-powered vehicle;
a first controller configured to control the transmission device; and
a first communicator configured to perform communication with a drive unit of the human-powered vehicle including a motor configured to apply a propulsion force to the human-powered vehicle,
the first controller being further configured to control the first communicator so that the first communicator sends first information to the drive unit in a case where the first controller shifts the transmission ratio, the first information including at least one of information related to a shifting time of the transmission ratio and information related to a shifting period of the transmission ratio.

2. The shifting device according to claim 1, further comprising
a second communicator configured to receive a shifting signal for shifting the transmission ratio from a shift-operating unit,
the first controller being configured to control the first communicator so that the first communicator sends the first information to the drive unit in a case where the second communicator receives the shifting signal.

3. The shifting device according to claim 2, wherein
the second communicator is configured to receive the shifting signal through wireless communication.

4. The shifting device according to claim 2, wherein
the first controller is configured to control the transmission device so that the transmission device initiates shifting of the transmission ratio at an initiation time after a predetermined period elapses in a case where the shifting signal is received; and
the first information includes at least one of the initiation time and the predetermined period.

5. The shifting device according to claim 1, wherein
the first controller is configured to determine at least one of the shifting time and the shifting period in accordance with at least one of the transmission ratio prior to shifting and the transmission ratio subsequent to shifting.

6. The shifting device according to claim 1, wherein
the first controller is configured to control the transmission device in accordance with a shifting signal sent from the drive unit.

7. The shifting device according to claim 1, further comprising
a communication housing provided with the first communicator and formed separately from the transmission device.

8. The shifting device according to claim 1, wherein
the first communicator is configured to send the first information to the drive unit through wired communication.

9. The shifting device according to claim 1, wherein
electric power is supplied from the drive unit.

10. The shifting device according to claim 1, wherein
the transmission device includes a derailleur.

11. A drive unit for a human-powered vehicle, the drive unit comprising:
a motor configured to apply a propulsion force to the human-powered vehicle;
a second controller configured to control the motor; and
a third communicator configured to perform communication with a shifting device of the human-powered vehicle, the shifting device being configured to shift a transmission ratio of the human-powered vehicle,
the second controller is configured to control the motor so that an assist level of the motor is changed in accordance with first information in a case where the third communicator receives the first information from the shifting device, the first information including at least one of information related to a shifting time of the transmission ratio and information related to a shifting period of the transmission ratio; and
the assist level being related to at least one of an upper limit value of an output of the motor, an assist ratio of the output of the motor to a human driving force input to the human-powered vehicle, and a response speed of the output of the motor to a change in the human driving force.

12. The drive unit according to claim 11, wherein
the second controller is configured to control the motor so as to decrease the assist level of the motor in accordance with the first information in a case where the third communicator receives the first information from the shifting device.

13. The drive unit according to claim 12, wherein
the shifting time includes an initiation time for initiating shifting of the transmission ratio; and
the second controller is configured to control the motor so as to initiate decreasing of the assist level at the initiation time.

14. The drive unit according to claim 11, wherein
the shifting period includes a predetermined shifting period from initiation of shifting of the transmission ratio to completion of shifting of the transmission ratio; and
the second controller is configured to control the motor so as to decrease the assist level in the predetermined shifting period.

15. The drive unit according to claim 11, wherein
the third communicator is configured to receive the first information through wired communication.

16. The drive unit according to claim 11, wherein
the drive unit is configured to supply the shifting device with electric power.

17. A control system for a human-powered vehicle, the control system comprising:
the shifting device according to any one of claims 1 to 10; and
a drive unit including:
a motor configured to apply a propulsion force to the human-powered vehicle,
a second controller configured to control the motor, and
a third communicator configured to perform communication with the shifting device;
the second controller being configured to control the motor so as to change an assist level of the motor in accordance with the first information; and
the assist level is related to at least one of an output of the motor, an upper limit value of the output of the motor, an assist ratio of the output of the motor to a human driving force input to the human-powered vehicle, and a response speed of the output of the motor to a change in the human driving force.

18. A communication device for a human-powered vehicle including a transmission device configured to shift a transmission ratio and a drive unit including a motor configured to apply a propulsion force to the human-powered vehicle, the communication device comprising:
a fourth communicator configured to perform communication with the drive unit; and
a third controller configured to control the fourth communicator so that the fourth communicator sends first information to the drive unit in a case where the transmission device shifts the transmission ratio, the first information including at least one of information related to a shifting time of the transmission ratio and information related to a shifting period of the transmission ratio.

19. The communication device according to claim 18, wherein
the third controller is configured to control the transmission device.

20. The communication device according to claim 18, further comprising:
a power receiver configured to receive electric power from the drive unit; and
a power transmitter configured to transmit the electric power received by the power receiver to the transmission device.
